(19) United States
(12) Patent Application Publication
(10) Pub. No.: US 2023/0017680 A1
(43) Pub. Date: Jan. 19, 2023

(54) DISPLAY DEVICE AND WATCH

(71) Applicant: Japan Display Inc., Tokyo (JP)

(72) Inventors: Akihiko FUJISAWA, Tokyo (JP); Kaoru ITO, Tokyo (JP); Tsutomu HARADA, Tokyo (JP); Takayuki NAKANISHI, Tokyo (JP)

(21) Appl. No.: 17/947,398

(22) Filed: Sep. 19, 2022

Related U.S. Application Data
(63) Continuation of application No. PCT/JP2021/010186, filed on Mar. 12, 2021.

(30) Foreign Application Priority Data
Mar. 19, 2020 (JP) 2020-049082

(51) Int. Cl. G06F 3/044; G06F 3/041; G04G 21/08

(52) U.S. Cl. CPC G06F 3/0448; G06F 3/041662; G06F 3/0412; G04G 21/08

(57) ABSTRACT

According to one embodiment, a display device includes a display panel and a ring-shaped electrode. The display panel includes a display area for displaying an image, a plurality of first electrodes arranged to surround the display area, and at least one second electrode arranged to surround the plurality of first electrodes. The ring-shaped electrode is arranged on the display panel and is arranged at a position overlapping with the second electrode in planar view. The ring-shaped electrode includes a protruding portion overlapping with at least one of the plurality of first electrodes in planar view.

### CROSS-REFERENCE TO RELATED APPLICATIONS

This application is a Continuation Application of PCT Application No. PCT/JP2021/010186, filed Mar. 12, 2021 and based upon and claiming the benefit of priority from Japanese Patent Application No. 2020-049082, filed Mar. 19, 2020, the entire contents of all of which are incorporated herein by reference.

### FIELD

Embodiments described herein relate generally to a display device and a watch.

### BACKGROUND

In recent years, wearable devices with a touch detection function (for example, wristwatch-type wearable devices, eyeglass-type wearable devices, and the like) have gradually been widespread. Such wearable devices are required to have both display quality when displaying an image and excellent operability by touch, and various developments are underway.

### BRIEF DESCRIPTION OF THE DRAWINGS

FIG. 1 is a plan view showing a configuration example of a display device according to an embodiment.

FIG. 2 is another plan view showing a configuration example of the display device according to the embodiment.

FIG. 3 is a view showing an example of a mounting mode of a touch controller, a display controller, and a CPU.

FIG. 4 is a view showing another example of the mounting mode of the touch controller, the display controller, and the CPU.

FIG. 5 is a view showing yet another example of the mounting mode of the touch controller, the display controller, and the CPU.

FIG. 6 is yet another plan view showing a configuration example of the display device according to the embodiment.

FIG. 7 is a cross-sectional view showing a configuration example of the display device according to the embodiment.

FIG. 8 is another cross-sectional view showing a configuration example of the display device according to the embodiment.

FIG. 9 is a view illustrating a principle of an operation for detecting a protruding portion of a ring-shaped electrode using a mutual capacitive scheme.

FIG. 10 is another view illustrating the principle of the operation for detecting the protruding portion of the ring-shaped electrode using the mutual capacitive scheme.

FIG. 11 is a chart showing a waveform of a detection signal read from the detection electrode.

FIG. 12 is yet another cross-sectional view showing the configuration example of the display device according to the embodiment.

FIG. 13 is a view illustrating a principle of an operation for detecting a protruding portion of a ring-shaped electrode using a self-capacitive scheme.

FIG. 14 is another view illustrating the principle of the operation for detecting the protruding portion of the ring-shaped electrode using the self-capacitive scheme.

FIG. 15 is a chart showing a waveform of a detection signal read from the detection electrode.

FIG. 16 is a view showing an application example of the display device according to the embodiments.

### DETAILED DESCRIPTION

In general, according to one embodiment, a display device includes a display panel and a ring-shaped electrode. The display panel includes a display area for displaying an image, a plurality of first electrodes arranged to surround the display area, and at least one second electrode arranged to surround the plurality of first electrodes. The ring-shaped electrode is arranged on the display panel and is arranged at a position overlapping with the second electrode in planar view. The ring-shaped electrode includes a protruding portion overlapping with at least one of the plurality of first electrodes in planar view.

According to another embodiment, a watch includes the above-described display device.

Several embodiments will be described hereinafter with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the embodiments, a display device with a touch detection function will be described as an example of the display device. There are various types of the touch detection method such as an optical type, a resistance type, a capacitive type, and an electromagnetic induction type. The capacitive type, of the various detection types described above, is a detection type utilizing the change in capacitance due to approach or contact of an object (for example, a finger), and has advantages that the detection can be implemented with a relatively simple structure, power consumption is low, and the like. In the embodiments, a display device with a touch detection function using a capacitive scheme will be mainly described.

It is assumed that the capacitive scheme includes a mutual capacitive scheme of generating an electric field using a pair of a transmitting electrode (drive electrode) and a receiving electrode (detecting electrode) arranged in a state of being separated from each other and detecting the change in the electric field due to approach or contact of an object, and a self-capacitive scheme of detecting the change in the capacitance due to approach or contact of an object using a single electrode.

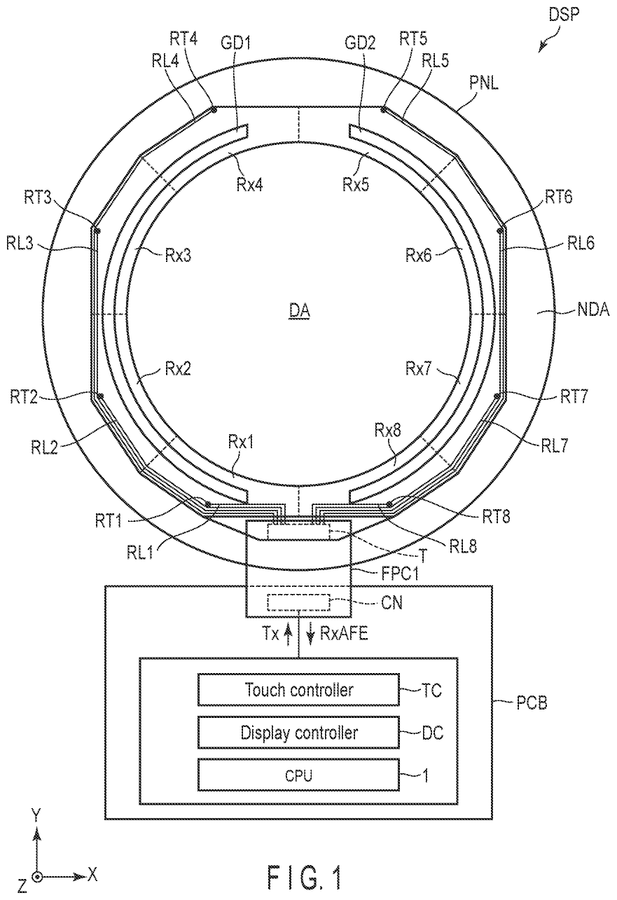

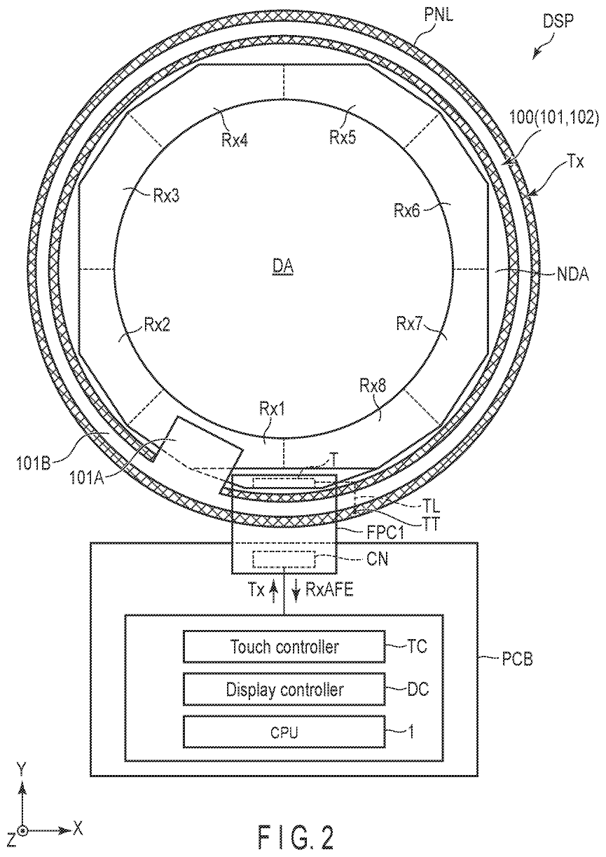

FIG. 1 and FIG. 2 are plan views showing a configuration example of a display device DSP of the embodiments. The configuration on the touch detection function is mainly shown in FIG. 1 and FIG. 2. FIG. 1 mainly shows detection electrodes Rx of the configuration on the touch detection function, and FIG. 2 mainly shows a drive electrode Tx, and a rotating body 100 (ring-shaped electrode 101) to be described later, of the configuration on the touch detection function. For example, a first direction X, a second direction Y, and a third direction Z are orthogonal to each other but may intersect at an angle other than ninety degrees. The first direction X and the second direction Y correspond to the directions parallel to a main surface of a substrate constituting the display device DSP, and the third direction Z corresponds to a thickness direction of the display device DSP. In the specification, a direction toward a tip of an arrow indicating the third direction Z is referred to as an upper direction, and a direction toward the opposite side from the tip of the arrow is referred to as a lower direction. In addition, an observation position at which the display device DSP is observed is assumed to be located on the tip side of the arrow indicating the third direction Z, and viewing from the observation position toward an X-Y plane defined by the first direction X and the second direction Y is referred to as planar view.

As shown in FIG. 1 and FIG. 2, the display device DSP comprises a display panel PNL, a flexible wiring board FPC1, a circuit board PCB, and a rotating body 100. The display panel PNL and the circuit board PCB are electrically connected via the flexible wiring board FPC1. More specifically, a terminal portion T of the display panel PNL and a connection portion CN of the circuit board PCB are electrically connected via the flexible wiring board FPC1.

The display panel PNL includes a display area DA for displaying an image and a frame-shaped non-display area NDA that surrounds the display area DA. An area of an inner circle of two concentric circles shown in FIG. 1 corresponds to the display area DA, and an area obtained by excluding the inner circle from an outer circle corresponds to the non-display area NDA. In the embodiments, it is exemplified that the display area DA has a circular shape and the non-display area NDA surrounding the display area DA also has the shape of the same type, but the shapes are not limited to this and the display area DA may not have the circular shape and the non-display area NDA may have a shape of a different type from that of the display area DA. For example, the display area DA may have a rectangular shape. Furthermore, when the display area DA has a rectangular shape, the non-display area NDA may have a circular shape which is the shape of a type different from that of the display area DA.

As shown in FIG. 1, a plurality of detection electrodes Rx1 to Rx8 are arranged so as to surround the display area DA, in the non-display area NDA. In the embodiments, eight detection electrodes Rx1 to Rx8 are shown, but the number of detection electrodes Rx arranged in the non-display area NDA is not limited to this, and any number of detection electrodes Rx may be arranged so as to surround the display area DA. The plurality of detection electrodes Rx1 to Rx8 are electrically connected to Rx terminal portions RT1 to RT8 via a conductive material (conductive beads) 31A included in a seal 30 though the details will be described later. In addition, Rx wiring lines RL1 to RL8 extending from the Rx terminal portions RT1 to RT8 are electrically connected to the terminal portion T arranged in the non-display area NDA. In the embodiments, it is exemplified that the Rx wiring lines RL1 to RL8 extend along the outer circumference of the detection electrodes Rx1 to Rx8, but the extending shapes of the detection wiring lines RL1 to RL8 may be other shapes. All the detection wiring lines RL1 to RL8 are wiring lines for outputting detection signals (RxAFE signals) from the detection electrodes Rx1 to Rx8.

As shown in FIG. 2, a ring-shaped drive electrode Tx is arranged so as to surround the detection electrodes Rx1 to Rx8 in the non-display area NDA. In the embodiments, one ring-shaped drive electrode Tx is exemplified, but the number of drive electrodes Tx arranged in the non-display area NDA is not limited to this, and a plurality of drive electrodes Tx may be arranged so as to surround the detection electrodes Rx1 to Rx8. In this case, the plurality of drive electrodes Tx are electrically connected to each other via wiring lines (not shown). The drive electrode Tx is electrically connected to a Tx terminal portion TT via a conductive material (conductive beads) 31B included in the seal 30 though the details will be described later. A Tx wiring line TL extending from the Tx terminal portion TT is electrically connected to the terminal portion T arranged in the non-display area NDA. The Tx wiring line TL is a wiring line for outputting a drive signal (Tx signal or a drive pulse) to the drive electrode Tx.

As shown in FIG. 2, the rotating body 100 that can rotate clockwise or counterclockwise is arranged at a position overlapping with the non-display area NDA in planar view so as to surround the detection electrodes Rx1 to Rx8. The rotating body 100 is composed of a ring-shaped electrode 101 shown in FIG. 2 and a movable portion 102 to be described later. The ring-shaped electrode 101 rotates together with the movable portion 102 rotated. Since the arrangement, constituent materials, and the like of the movable portion 102 are described later, its detailed description is omitted here.

As shown in FIG. 2, the ring-shaped electrode 101 comprises a protruding portion 101A and a ring portion (annular portion) 101B. The protruding portion 101A of the ring-shaped electrode 101 overlaps with at least one detection electrode Rx in planar view. FIG. 2 shows a case where the protruding portion 101A of the ring-shaped electrode 101 overlaps with the detection electrode Rx1 in planar view, but the present invention is not limited to this, and the detection electrode Rx with which the protruding portion 101A of the ring-shaped electrode 101 overlaps in planar view changes as appropriate by rotating the movable portion 102 clockwise or counterclockwise. The ring portion 101B of the ring-shaped electrode 101 overlaps with the drive electrode Tx in planar view. A width of the ring portion 101B of the ring-shaped electrode 101 may be the same as that of the drive electrode Tx, larger than that of the drive electrode Tx, or smaller than that of the drive electrode Tx. In addition, an edge of the rotating body 100 and an edge of the drive electrode Tx may be flush with each other. The ring-shaped electrode 101 is not electrically connected to the other constituent elements constituting the display device DSP, and is floating. In the specification described herein, floating is assumed to refer to a state in which a conductor is not electrically connected anywhere.

As shown in FIG. 1, scanning line drive circuits GD1 and GD2 are arranged on the right and left sides of the non-display area NDA, and the scanning line drive circuits GD1 and GD2 and the detection electrodes Rx1 to Rx8 overlap in planar view. Since details of the scanning line drive circuits GD1 and GD2 are described later, their detailed description are omitted here.

As shown in FIG. 1 and FIG. 2, a touch controller TC, a display controller DC, a CPU 1, and the like are arranged on the circuit board PCB. The touch controller TC outputs a drive signal to the drive electrode Tx arranged on the display panel PNL, and receives input of the detection signals output from the detection electrodes Rx1 to Rx8 (i.e., detects the protruding portion 101A of the ring-shaped electrode 101). The touch controller TC may be implemented separately as a drive circuit that outputs a drive signal to the drive electrode Tx and a detection circuit that receives input of the detection signals output from the detection electrodes Rx1 to Rx8.

The display controller DC outputs a video signal indicating an image displayed on the display area DA of the display panel PNL and control signals for controlling the scanning line drive circuits GD1 and GD2.

The CPU 1 executes operations corresponding to output of synchronization signals that define the operation timing of the touch controller TC and the display controller DC, a current position of the protruding portion 101A of the ring-shaped electrode 101 indicated by the detection signal whose input is received by the touch controller TC, and the change in the position of the protruding portion 101A of the ring-shaped electrode 101, and the like.

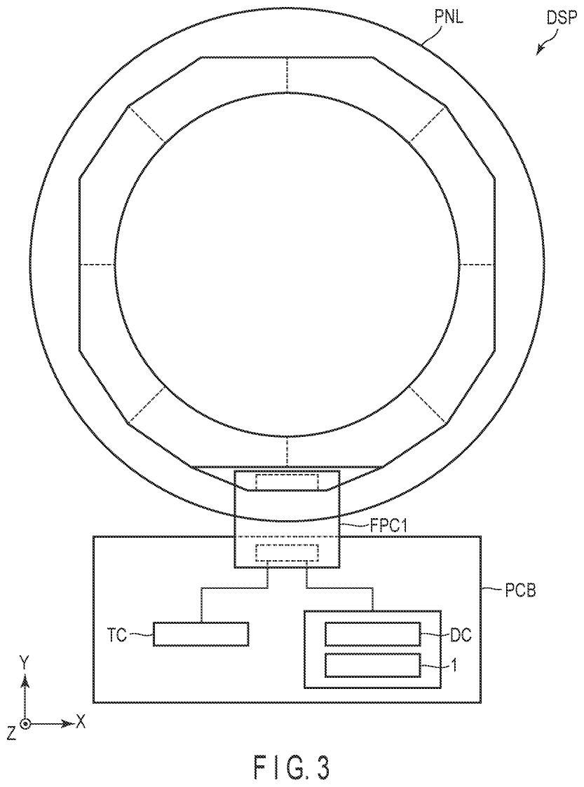

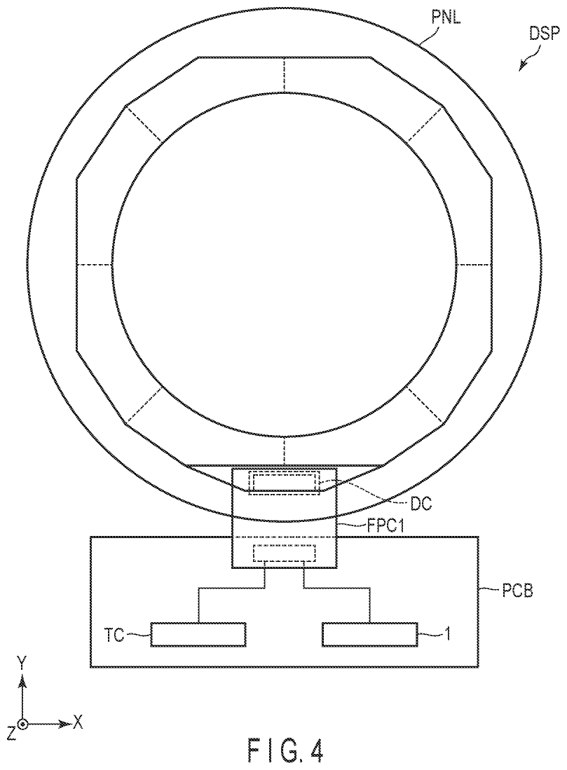

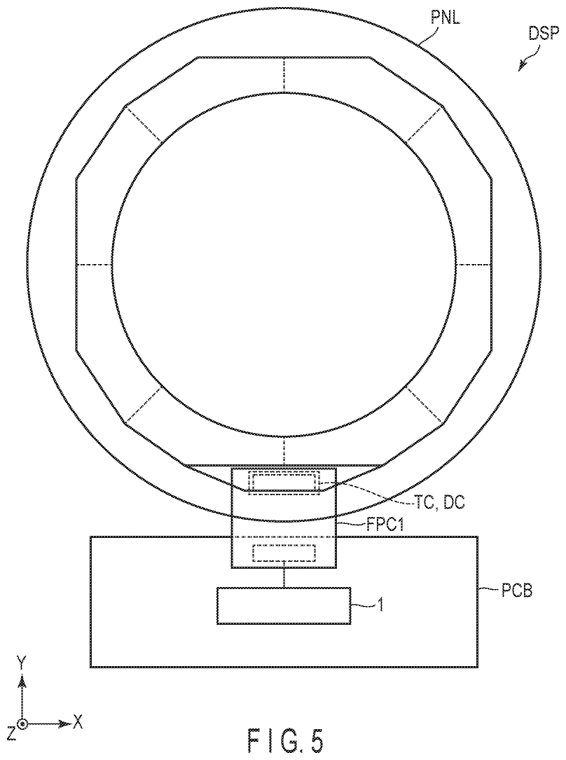

In FIG. 1 and FIG. 2, it is exemplified that the touch controller TC, the display controller DC, and the CPU 1 are implemented by one semiconductor chip, but their mounting form is not limited to this and, for example, each portion may be mounted on the circuit board PCB while separating the only touch controller TC as a different body as shown in FIG. 3, the touch controller TC and the CPU 1 may be separately mounted on the circuit board PCB and the display controller DC may be mounted on the display panel PNL by Chip On Glass (COG) as shown in FIG. 4, or only the CPU 1 may be mounted on the circuit board PCB and the touch controller TC and the display controller DC may be mounted on the display panel PNL by COG as shown in FIG. 5.

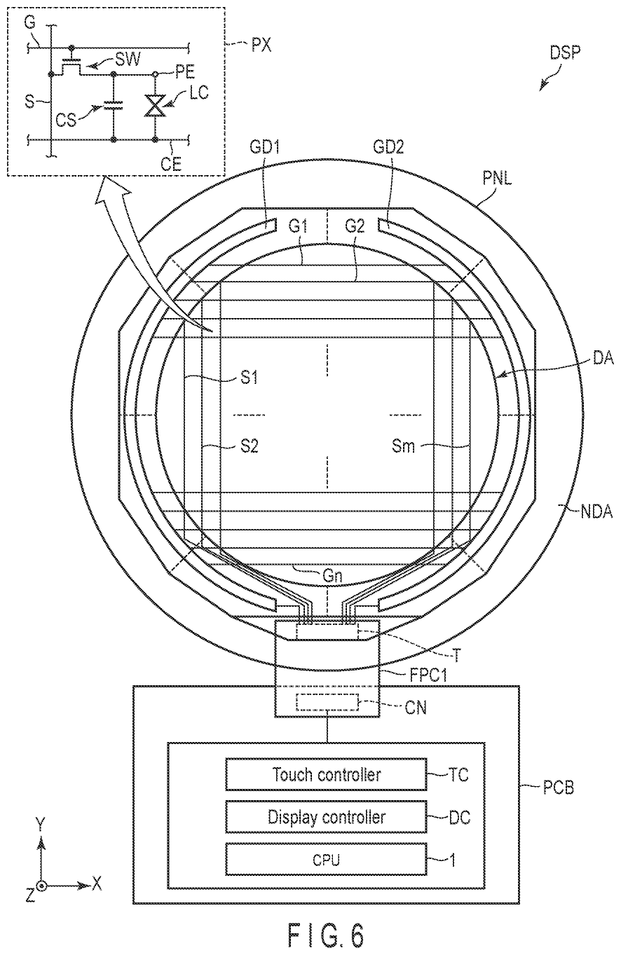

FIG. 6 is another plan view showing a configuration example of the display device DSP of the embodiments. The configuration on the image display function is mainly shown in FIG. 6. As shown in FIG. 6, the display panel PNL comprises n scanning lines G (G1 to Gn) and m signal lines S (S1 to Sm) in the display area DA. Both n and m are positive integers, and n may be equal to m or n may be different from m. The scanning lines G extend in the first direction X and are spaced apart and arranged in the second direction Y. The signal lines S extend in the second direction Y and are spaced apart and arranged in the first direction X. Pixels PX are arranged in an area partitioned by the scanning line G and the signal line S. In other words, the display panel PNL comprises a large number of pixels PX arrayed in a matrix in the first direction X and the second direction Y, in the display area DA.

As shown and enlarged in FIG. 6, each pixel PX comprises a switching element SW, a pixel electrode PE, a common electrode CE, a liquid crystal layer LC and the like. The switching element SW is constituted by, for example, a thin-film transistor (TFT) and is electrically connected to the scanning line G and the signal line S. The scanning line G is electrically connected to the switching element SW in each of the pixels PX arranged in the first direction X. The signal line S is electrically connected to the switching element SW in each of the pixels PX arranged in the second direction Y. The pixel electrode PE is electrically connected to the switching element SW. Each of the pixel electrodes PE is opposed to the common electrode CE, and drives the liquid crystal layer LC by an electric field produced between the pixel electrode PE and the common electrode CE. A capacitor CS is formed between, for example, an electrode having the same electric potential as the common electrode CE and an electrode having the same potential as the pixel electrode PE.

At least one of ends of the scanning line G is electrically connected to at least one of the scanning line drive circuits GD1 and GD2. The scanning line drive circuits GD1 and GD2 are electrically connected to the terminal portion T, and a control signal from the display controller DC is input to the scanning line drive circuits GD1 and GD2. The scanning line drive circuits GD1 and GD2 output scanning signals for controlling the operation of writing the video signal to each pixel PX, to the scanning line G, in accordance with the input control signal. One of ends of the signal line S is electrically connected to the terminal portion T, and a video signal from the display controller DC is input to the signal line S.

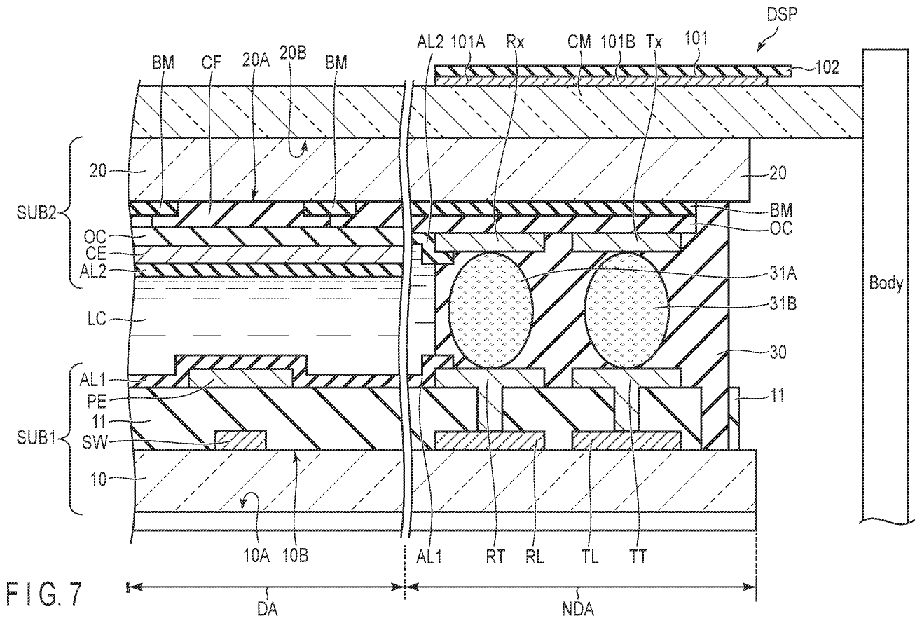

FIG. 7 is a cross-sectional view showing a configuration example of the display device DSP, illustrating a cross-section including the protruding portion 101A of the ring-shaped electrode 101. Each of the configuration on the display area DA side and the configuration on the non-display area NDA side will be described below.

The display panel PNL comprises a first substrate SUB1, a second substrate SUB2, a liquid crystal layer LC, a seal 30, a backlight unit BL, and a cover member CM. The first substrate SUB1 and the second substrate SUB2 are formed in a flat plate shape parallel to the X-Y plane. The first substrate SUB1 and the second substrate SUB2 overlap with each other in planar view and are bonded by the seal 30. The liquid crystal layer LC is held between the first substrate SUB1 and the second substrate SUB2 and is sealed by the seal 30.

A backlight device BL is arranged on a back side of the first substrate SUB1 as an illumination device for illuminating the display panel PNL. Various types of backlight devices can be employed as the backlight device BL and, for example, backlight devices using a light-emitting diode (LED), a cold-cathode tube (CCFL) or the like as the light source can be used.

It is exemplified in FIG. 7 that the display device DSP is a transmissive display device in which the backlight device BL is arranged, but the display device DSP may be a reflective display device in which the backlight device BL is not arranged. In this case, instead of arranging the backlight device BL, for example, a reflective electrode is arranged on or under the pixel electrode PE to be described later. The reflective electrode reflects light incident from the second substrate SUB2 side and makes the light incident on the liquid crystal layer LC to illuminate the display panel PNL.

A cover member CM is arranged on the second substrate SUB2. As the cover member CM, for example, an insulating substrate such as a glass substrate or a plastic substrate can be used. Although not shown in FIG. 7, a light-shielding layer may be arranged between the second substrate SUB2 and the cover member CM on the non-display area NDA side.

On the display area DA side, as shown in FIG. 7, the first substrate SUB1 comprises a transparent substrate 10, a switching element SW, a planarization film 11, a pixel electrode PE, and an alignment film AL1. The first substrate SUB1 comprises the scanning line G, the signal line S, and the like shown in FIG. 6 in addition to the above-described configuration, but their illustration is omitted FIG. 7.

The transparent substrate 10 comprises a main surface (lower surface) 10A and a main surface (upper surface) 10B on a side opposite to the main surface 10A. The switching element SW is arranged on the main surface 10B side. The planarization film 11 is composed of at least one or more insulating films and covers the switching element SW. The pixel electrode PE is arranged for each pixel PX on the flattening film 12. The alignment film AL1 covers the pixel electrodes PE.

The switching element SW is simplified in FIG. 7, but the switching element SW actually includes a semiconductor layer and various electrodes. In addition, although not shown in FIG. 7, the switching element SW and the pixel electrode PE are electrically connected to each other through an opening portion formed in the planarization film 11. Furthermore, as described above, the scanning line G and the signal line S that are not shown in FIG. 7 are arranged, for example, between the transparent substrate 10 and the planarization film 11.

On the display area DA side, as shown in FIG. 7, the second substrate SUB2 comprises a transparent substrate 20, a light-shielding film BM, a color filter CF, an overcoat layer OC, a common electrode CE, and an alignment film AL2.

The transparent substrate 20 comprises a main surface (lower surface) 20A and a main surface (upper surface) 20B on a side opposite to the main surface 20A. The main surface 20A of the transparent substrate 20 is opposed to the main surface 10B of the transparent substrate 10. The light-shielding film BM partitions each pixel PX. The color filter CF is opposed to the pixel electrode PE, and a part of the color filter CF overlaps with the light-shielding layer BM. The color filter CF includes a red color filter, a green color filter, a blue color filter, and the like. The overcoat layer OC covers the color filter CF. The common electrode CE is arranged across a plurality of pixels PX and is opposed to a plurality of pixel electrodes PE in the third direction Z. In addition, the common electrode CE covers the overcoat layer OC. The alignment film AL2 covers the common electrode CE.

The liquid crystal layer LC is arranged between the main surface 10B and the main surface 20A and is in contact with the alignment films AL1 and AL2.

The transparent substrates 10 and 20 are, for example, insulating substrates such as glass substrates or plastic substrates. The planarization film 11 includes, for example, a transparent insulating material such as silicon oxide, silicon nitride, silicon oxynitride or acrylic resin. For example, the planarization film 11 includes an inorganic insulating film and an organic insulating film. The pixel electrodes PE and the common electrode CE are transparent electrodes formed of, for example, a transparent conductive material such as indium tin oxide (ITO) or indium zinc oxide (IZO). The light-shielding layer BM is formed of, for example, an untransparent metal material such as molybdenum (Mo), aluminum (Al), tungsten (W), titanium (Ti), or silver (Ag). The alignment films AL1 and AL2 are horizontal alignment films having an alignment restriction force substantially parallel to the X-Y plane. The alignment restriction force can be imparted by a rubbing treatment or an optical alignment treatment.

On the non-display area NDA side, as shown in FIG. 7, the first substrate SUB1 comprises the transparent substrate 10, the Rx wiring line RL, the Tx wiring line TL, the planarization film 11, the Rx terminal portion RT, the Tx terminal portion TT, and the alignment film AL1. Detailed description of the configuration already described on the display area DA side will be omitted below.

The Rx wiring line RL and the Tx wiring line TL are arranged on the transparent substrate 10. The Rx wiring line RL and the Tx wiring line TL are arranged in the same layer as the switching element SW on the display area DA side. The Rx wiring line RL and the Tx wiring line TL may be arranged in the same layer or may be arranged in layers different from each other. The Rx terminal portion RT and the Tx terminal portion TT are arranged on the planarization film 11. The Rx terminal portion RT and the Tx terminal portion TT are arranged in the same layer as the pixel electrode PE on the display area DA side, and are formed of the same transparent conductive material as the pixel electrode PE. The Rx wiring line RL and the Rx terminal portion RT are electrically connected to each other via an opening portion formed in the planarization film 11. Similarly, the Tx wiring line TL and the Tx terminal portion TT are electrically connected to each other via an opening portion formed in the planarization film 11. Although not shown in FIG. 7, the Rx wiring line RL and the Tx wiring line TL are electrically connected to connection terminals of the flexible wiring board FPC1.

Although not shown in FIG. 7, a terminal portion T is arranged on a portion of the main surface 10B of the transparent substrate 10, which is not opposed to the main surface 20A, and the terminal portion T is electrically connected to the flexible wiring board FPC1. The terminal portion T is formed by covering a metal material such as Al with ITO or the like from the viewpoint of preventing corrosion.

On the non-display area NDA side, as shown in FIG. 7, the second substrate SUB2 comprises the transparent substrate 20, the light-shielding film BM, the overcoat layer OC, the detection electrode Rx, the drive electrode Tx, and the alignment film AL2. Detailed description of the configuration already described on the display area DA side will be omitted below.

On the non-display area NDA side, unlike the display area DA side, the light-shielding film BM is arranged over a substantially entire surface of the transparent substrate 20. The overcoat layer OC covers the light-shielding film BM. The detection electrode Rx is arranged in an island shape on the overcoat layer OC side and is opposed to the Rx terminal portion RT in the third direction Z. The detection electrode Rx is arranged in the same layer as the common electrode CE on the display area DA side, and is formed of the same transparent conductive material as the common electrode CE. The drive electrode Tx is arranged on the overcoat layer OC side and is opposed to the Tx terminal portion TT in the third direction Z. The drive electrode Tx is arranged adjacent to the detection electrode Rx with a predetermined interval. The drive electrode Tx is arranged farther from the display area DA than the adjacent detection electrode Rx. The drive electrode Tx is arranged in the same layer as the common electrode CE on the display area DA side, and is formed of the same transparent conductive material as the common electrode CE.

The first substrate SUB1 and the second substrate SUB2 are bonded to each other by the seal 30 and, in the non-display area NDA, the Rx terminal portion RT of the first substrate SUB1 and the detection electrode Rx of the second substrate SUB2 are electrically connected to each other by the conductive material (conductive beads) 31A included in the seal 30. In addition, in the non-display area NDA, the Tx terminal portion TT of the first substrate SUB1 and the drive electrode Tx of the second substrate SUB2 are electrically connected to each other by the conductive material (conductive beads) 31B included in the seal 30. The conductive material 31A and the conductive material 31B are arranged so as not to be in contact with each other.

On the non-display area NDA side, a cover member CM is arranged on the second substrate SUB2, similarly to the display area DA side. On the non-display area NDA side, the cover member CM is connected (bonded) to the main body (body) of the display device DSP.

On the non-display area NDA side, the rotating body 100 is arranged on the cover member CM. More specifically, the ring-shaped electrode 101 and the movable portion 102 are arranged in this order on the cover member CM. Since a cross section including the protruding portion 101A of the ring-shaped electrode 101 is shown in FIG. 7, the ring-shaped electrode 101 is opposed to the detection electrode Rx and the drive electrode Tx in the third direction Z. A portion of the ring-shaped electrode 101, which is opposed to the detection electrode Rx in the third direction Z, corresponds to the protruding portion 101A of the ring-shaped electrode 101. In addition, a portion of the ring-shaped electrode 101, which is opposed to the drive electrode Tx in the third direction Z, corresponds to the ring portion 101B of the ring-shaped electrode 101. The ring-shaped electrode 101 is formed of, for example, the same transparent conductive material as the detection electrode Rx and the drive electrode Tx. A movable portion 102 is arranged on the ring-shaped electrode 101 so as to cover the entire ring-shaped electrode 101. According to another expression, the movable portion 102 extends more closely to the main body of the display device DSP than to the ring-shaped electrode 101. The movable portion 102 is formed of an insulating member. When the movable portion 102 is rotated, the ring-shaped electrode 101 connected to the movable portion 102 also rotates in the same manner. In other words, the ring-shaped electrode 101 is rotated by rotating the movable portion 102.

FIG. 7 illustrates a case where the liquid crystal mode of the display panel PNL is the so-called vertical field mode, which is classified into two categories according to the direction of the electric field applied to change the orientation of the liquid crystal molecules contained in the liquid crystal layer LC. However, the present structure is also applicable to the case where the liquid crystal mode is the so-called horizontal field mode.

The above-described vertical field mode includes, for example, a Twisted Nematic (TN) mode, a Vertical Alignment (VA) mode, and the like. In addition, the above-described horizontal field mode includes, for example, an In-Plane Switching (IPS) mode, a Fringe Field Switching (FFS) mode which is one of the IPS modes, and the like.

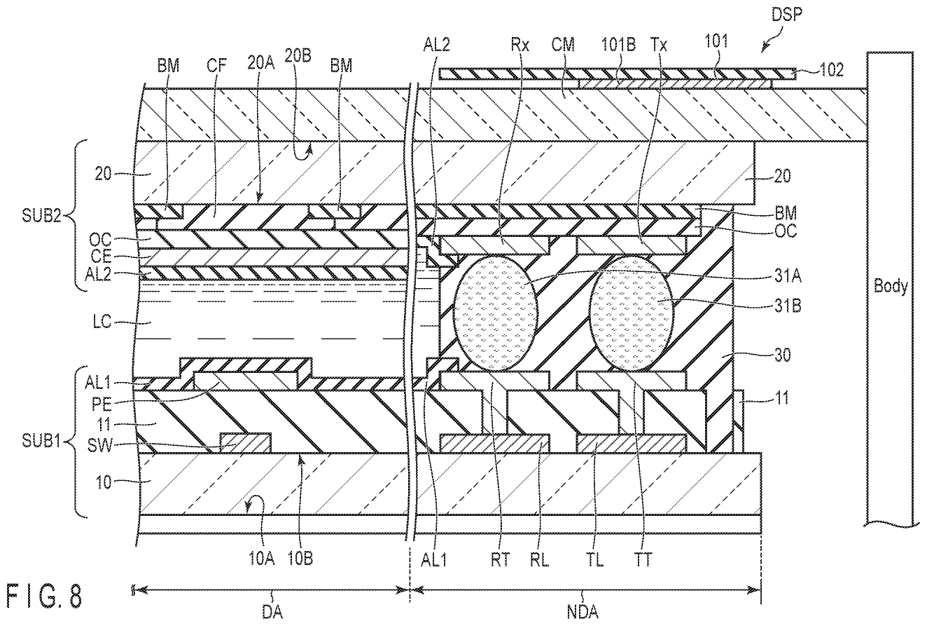

FIG. 8 shows a cross section of the display device DSP, which does not include the protruding portion 101A of the ring-shaped electrode 101, unlike FIG. 7. In the following descriptions, only the parts different from FIG. 7 are described, and the description of the parts similar to those in FIG. 7 are omitted.

In the cross section which does not include the protruding portion 101A of the ring-shaped electrode 101, as shown in FIG. 8, the ring-shaped electrode 101 is opposed to drive electrode Tx in the third direction Z, but is not opposed to the detection electrode Rx in the third direction Z. FIG. 8 shows a case where no portion is arranged between the movable portion 102 opposed to the detection electrode Rx and the cover member CM in the third direction Z, but the embodiments are not limited to this, and the same insulating member as the movable portion 102 or the like may be arranged.

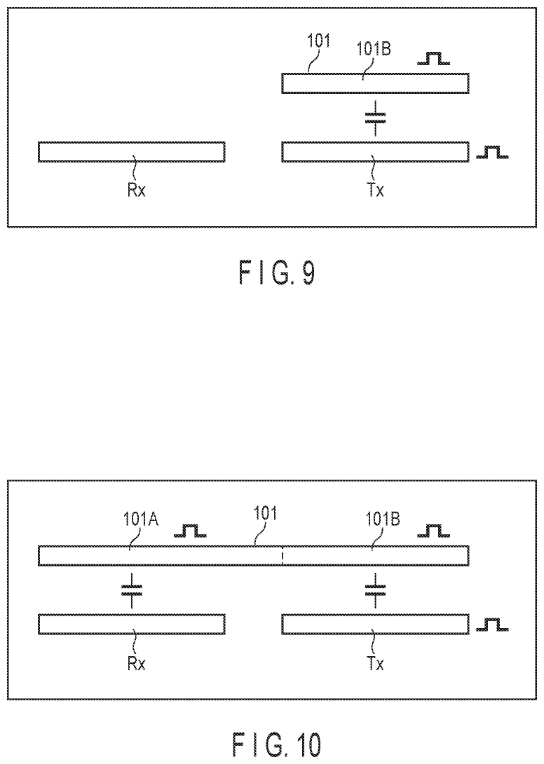

Next, a principle of operation for detecting the protruding portion 101A of the ring-shaped electrode 101 using the mutual capacitive scheme will be described with reference to FIG. 9 and FIG. 10. FIG. 9 shows a state in which the detection electrode Rx is not opposed to the protruding portion 101A of the ring-shaped electrode 101, and FIG. 10 shows a state in which the detection electrode Rx is opposed to the protruding portion 101A of the ring-shaped electrode 101.

As shown in FIG. 9, when a drive signal is input from the touch controller TC to the drive electrode Tx in a state in which the protruding portion 101A of the ring-shaped electrode 101 is not opposed to the detection electrode Rx, a detection signal (RxAFE signal) affected by the electrostatic capacitive coupling generated between the detection electrode Rx and the adjacent drive electrode Tx is read from the detection electrode Rx, and the detection signal is output to the touch controller TC. When the drive signal is input to the drive electrode Tx, an electrostatic capacitive coupling also occurs between the drive electrode Tx and the opposed ring portion 101B of the ring-shaped electrode 101, but the electrostatic capacitive coupling occurring between the drive electrode Tx and the ring portion 101B of the ring-shaped electrode 101 is considered to be a negligible level with reference to the above electrostatic capacitive coupling occurring between the detection electrode Rx and the drive electrode Tx. According to another expression, it can also be considered that the capacitance formed between the drive electrode Tx and the ring portion 101B of the ring-shaped electrode 101 is not substantially loaded on the detection electrode Rx.

In contrast, as shown in FIG. 10, when the drive signal is input from the touch controller TC to the drive electrode Tx in a state in which the protruding portion 101A of the ring-shaped electrode 101 is opposed to the detection electrode Rx, the detection signal (RxAFE signal) affected by the electrostatic capacitive coupling occurring between the detection electrode Rx and the adjacent drive electrode Tx, and the electrostatic capacitive coupling occurring between the detection electrode Rx and the opposed protruding portion 101A of the ring-shaped electrode 101 is read from the detection electrode Rx opposed to the protruding portion 101A of the ring-shaped electrode 101. The read detection signal is output to the touch controller TC. Due to the fact that the ring-shaped electrode 101 is floating, the detection electrode Rx opposed to the protruding portion 101A of the ring-shaped electrode 101 forms a capacitance between the detection electrode and the protruding portion 101A and between the detection electrode and the adjacent drive electrode Tx. In other words, the capacitance formed by the detection electrode Rx opposed to the protruding portion 101A of the ring-shaped electrode 101 is larger than the capacitance formed by the detection electrode Rx which is not opposed to the protruding portion 101A of the ring-shaped electrode 101. According to this, a detection signal having an amplitude larger than the waveform of the detection signal read from the detection electrode Rx which is not opposed to the protruding portion 101A of the ring-shaped electrode 101 is read from the detection electrode Rx opposed to the protruding portion 101A of the ring-shaped electrode 101. For this reason, the influence of the electrostatic capacitive coupling generated between the detection electrode Rx and the drive electrode Tx can be eliminated by setting a threshold value of the signal detected from the detection electrode Rx to a predetermined value.

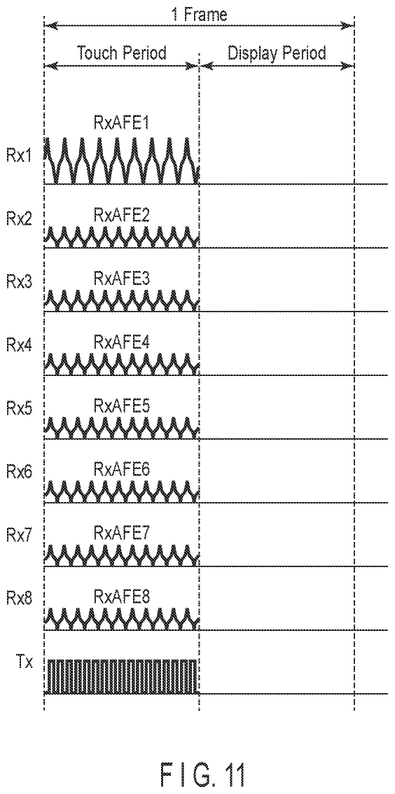

FIG. 11 is a chart showing waveforms of detection signals RxAFE1 to RxAFE8 read from the detection electrodes Rx1 to Rx8. In FIG. 11, it is assumed that only the detection electrode Rx1 is opposed to the protruding portion 101A of the ring-shaped electrode 101 and that the other detection electrodes Rx2 to Rx8 are not opposed to the protruding portion 101A of the ring-shaped electrode 101.

In the embodiments, one frame period is composed of a touch detection period TP for detecting a touch and a display period DP for displaying an image. In the embodiments, when the touch detection period TP ends the period transitions to the display period DP, and when the display period DP ends, the touch detection period TP included in one next frame period is started. In the embodiments, it is assumed that one frame period is composed of one touch detection period TP and one display period DP, but the embodiments are not limited to this, and a plurality of touch detection periods TP and a plurality of display periods DP may be included in one frame period.

As shown in FIG. 11, when the touch detection period TP in a certain frame period is started, a drive signal is input (supplied) to the drive electrode Tx. When the drive signal is input to the drive electrode Tx, the detection signals RxAFE1 to RxAFE8 are read from the detection electrodes Rx1 to Rx8, and these detection signals RxAFE1 to RxAFE8 are output to the touch controller TC. Since it is assumed in FIG. 11 that only the detection electrode Rx1 is opposed to the protruding portion 101A of the ring-shaped electrode 101 and the other detection electrodes Rx2 to Rx8 are not opposed to the protruding portion 101A of the ring-shaped electrode 101, the waveform of the detection signal RxAFE1 read from the detection electrode Rx1 has a larger amplitude than the waveforms of the detection signals RxAFE2 to RxAFE8 read from the other detection electrodes Rx2 to Rx8 as shown in FIG. 11. According to this, the touch controller TC detects a state in which the protruding portion 101A of the ring-shaped electrode 101 is on the detection electrode Rx1 corresponding to the detection signal RxAFE1 having a larger amplitude than the other detection signals RxAFE2 to RxAFE8.

The touch controller TC may obtain the detection signals read from all the detection electrodes Rx, find the detection signal having a larger amplitude than the other signals by comparing these waveforms, and detect the state in which the protruding portion 101A of the ring-shaped electrode 101 is located on the detection electrode Rx corresponding to the detection signal having a larger amplitude than the other signals. Alternatively, the touch controller TC may store the waveform of the detection signal read from the detection electrode Rx in a state of being not opposed to the protruding portion 101A of the ring-shaped electrode 101 in a memory (not shown) or the like in advance and, when the waveform of the detection signal read from the detection electrode Rx has an amplitude larger than the waveform of the detection signal stored in the memory in advance, may detect a state in which the protruding portion 101A of the ring-shaped electrode 101 is located on the detection electrode Rx corresponding to the detection signal. Alternatively, the touch controller TC can identify the waveform of the detection signal read from the detection electrode Rx in a state of being not opposed to the protruding portion 101A of the ring-shaped electrode 101 and the waveform of the detection signal read from the detection electrode Rx in a state of being opposed to the protruding portion 101A of the ring-shaped electrode 101, by setting a threshold value of the detection circuit to a predetermined level. In addition, the touch controller TC can detect a state in which the protruding portion is opposed between two detection electrodes by providing a plurality of threshold values of the detection circuit. For example, when the protruding portion 101A is opposed between two detection electrodes, the amplitude of the detection signal is smaller than that when the protruding portion is opposed to only one detection electrode, and is larger than the amplitude of the detection signal output from the detection electrode Rx to which the protruding portion 101A is not opposed. For this reason, the amplitudes of the plurality of detection waveforms can be detected and a state in which the protruding portion is opposed between the two detection electrodes can also be detected by setting a plurality of threshold values of the detection circuit.

As described above, by comprising the protruding portion 101A overlapping with at least one detection electrode Rx in planar view and the ring portion 101B overlapping with the drive electrode Tx in planar view, and by providing the protruding portion 101A which is floating, the capacitance formed by the detection electrode Rx opposed to the protruding portion 101A of the ring-shaped electrode 101 can be made larger than the capacitance formed by the detection electrode Rx which is not opposed to the protruding portion 101A of the ring-shaped electrode 101. According to this, the waveform of the detection signal read from the detection electrode Rx opposed to the protruding portion 101A of the ring-shaped electrode 101 can be made different from the waveforms of the detection signals read from the other detection electrodes Rx (more specifically, an amplitude larger than the waveforms of the detection signals read from the other detection electrodes Rx can be obtained). As a result, the touch controller TC can detect (the position of) the protruding portion 101A of the ring-shaped electrode 101.

It has been described above that the position of the protruding portion 101A of the ring-shaped electrode 101 is detected by the mutual capacitive scheme. Detecting the position of the protruding portion 101A of the ring-shaped electrode 101 by the self-capacitive scheme will be described below.

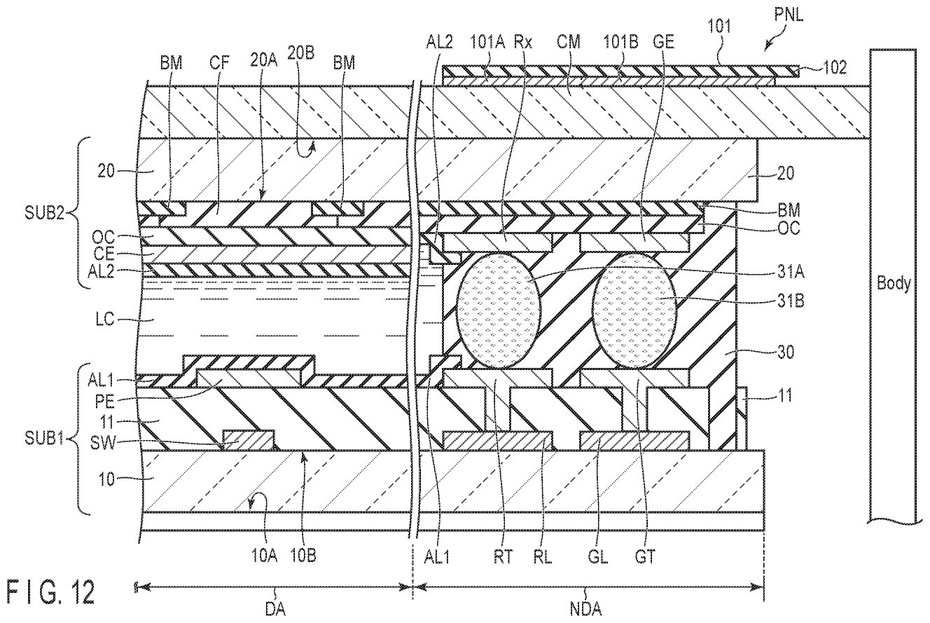

FIG. 12 is a cross-sectional view showing a configuration example of a display device DSP capable of detecting the position of the protruding portion 101A of the ring-shaped electrode 101 by the self-capacitive scheme, unlike FIG. 7, illustrating a cross-section including the protruding portion 101A of the ring-shaped electrode 101.

The configuration shown in FIG. 12 is different from the configuration shown in FIG. 7 in that a GND electrode GE which is connected to the GND potential (to which a GND voltage is applied) is provided instead of the drive electrode Tx, that a GND terminal portion GT which is electrically connected to the GND electrode GE via the conductive material (conductive beads) 31B is provided instead of the Tx terminal portion TT, and that a GND wiring line GL which is electrically connected to the GND terminal portion GT via an opening portion formed in the planarization film 11 is provided instead of the Tx wiring line TL shown in FIG. 7. The GND electrode GE is formed of, for example, the same transparent conductive material as the detection electrode Rx. FIG. 12 shows a configuration in which the GND electrode GE to which the GND voltage is applied is provided, but the embodiments are not limited to this, and an electrode to which a constant voltage (reference voltage) is applied may be provided instead of the GND electrode GE.

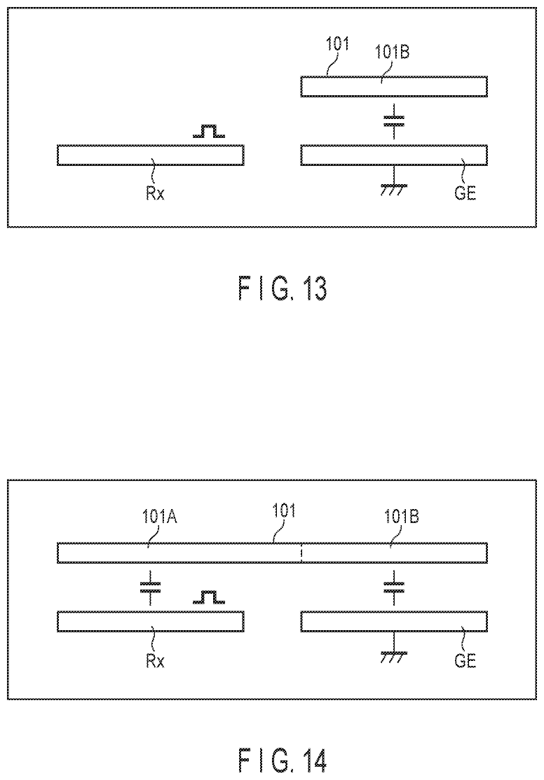

FIG. 13 and FIG. 14 are views illustrating a principle of operation for detecting the protruding portion 101A of the ring-shaped electrode 101 using the self-capacitive scheme. FIG. 13 shows a state in which the detection electrode Rx is not opposed to the protruding portion 101A of the ring-shaped electrode 101, and FIG. 14 shows a state in which the detection electrode Rx is opposed to the protruding portion 101A of the ring-shaped electrode 101.

As shown in FIG. 13, when a drive signal is input to the detection electrode Rx in a state of being not opposed to the protruding portion 101A of the ring-shaped electrode 101, the capacitance loaded on the detection electrode Rx can be ignored and, therefore, a detection signal (RxAFE signal) of a waveform corresponding to the input drive signal is read from the detection electrode Rx and the detection signal is output to the touch controller TC.

In contrast, as shown in FIG. 14, when a drive signal is input to the detection electrode Rx in a state of being opposed to the protruding portion 101A of the ring-shaped electrode 101, the capacitance caused by the electrostatic capacitive coupling which occurs between the detection electrode Rx and the opposed protruding portion 101A of the ring-shaped electrode 101 is loaded on the detection electrode Rx. For this reason, a detection signal having an amplitude smaller than the waveform of the detection signal read from the detection electrode Rx in a state of being not opposed to the protruding portion 101A of the ring-shaped electrode 101 is read from the detection electrode Rx, and the detection signal is output to the touch controller TC.

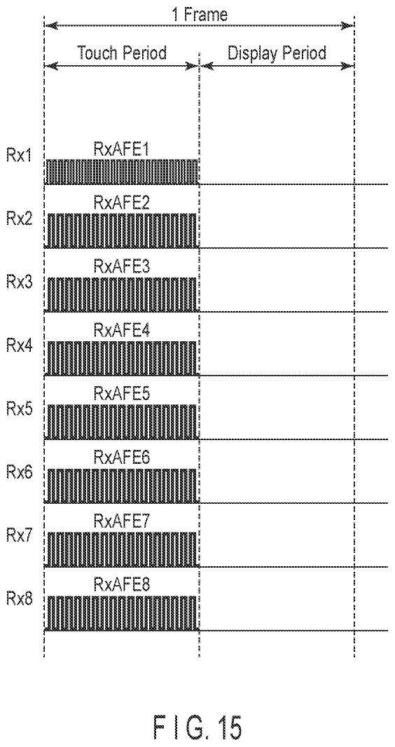

FIG. 15 is a chart showing waveforms of the detection signals RxAFE1 to RxAFE8 read from the detection electrodes Rx1 to Rx8 in the configuration shown in FIG. 12. In FIG. 15, it is assumed that only the detection electrode Rx1 is opposed to the protruding portion 101A of the ring-shaped electrode 101 and that the other detection electrodes Rx2 to Rx8 are not opposed to the protruding portion 101A of the ring-shaped electrode 101. In addition, FIG. 15 shows the amplitudes in a case where the detection electrodes Rx1 to Rx8 are driven with a predetermined load. In other words, since the detection electrodes are driven with a predetermined load, the larger the capacitance of the detection electrodes Rx, the smaller the driven amplitudes. The magnitude of the capacitance of the detection electrodes Rx can be detected by reading the amplitudes with the detection circuit.

As shown in FIG. 15, when the touch detection period TP in a certain frame period is started, drive signals are input (supplied) to the detection electrodes Rx1 to Rx8. The detection signals RxAFE1 to RxAFE8 of the waveforms corresponding to the input drive signals are read from the detection electrodes Rx1 to Rx8, and these detection signals RxAFE1 to RxAFE8 are output to the touch controller TC. Since it is assumed in FIG. 15 that only the detection electrode Rx1 is opposed to the protruding portion 101A of the ring-shaped electrode 101 and that the other detection electrodes Rx2 to Rx8 are not opposed to the protruding portion 101A of the ring-shaped electrode 101, the waveform of the detection signal RxAFE1 read from the detection electrode Rx1 has a smaller amplitude than the waveforms of the detection signals RxAFE2 to RxAFE8 read from the other detection electrodes Rx2 to Rx8, as shown in FIG. 15. According to this, the touch controller TC detects that the protruding portion 101A of the ring-shaped electrode 101 is located on the detection electrode Rx1 corresponding to the detection signal RxAFE1 having an amplitude smaller than that of the other detection signals RxAFE2 to RxAFE8. In the self-capacitive scheme as well as the mutual capacitive scheme, the touch controller TC can detect a state in which the protruding portions is opposed between the two detection electrodes by setting a plurality of threshold values of the detection circuit.

By obtaining the detection signals read from all the detection electrodes Rx and comparing their waveforms, the touch controller TC may find a detection signal having an amplitude smaller than the others and detect the protruding portion 101A of the ring-shaped electrode 101, which is located on the detection electrode Rx corresponding to the detection signal having the amplitude smaller than the others. Alternatively, the touch controller TC may store the waveform of the detection signal read from the detection electrode Rx in a state of being not opposed to the protruding portion 101A of the ring-shaped electrode 101, in a memory (not shown) or the like in advance and, when the waveform of the detection signal read from the detection electrode Rx has an amplitude smaller than the waveform of the detection signal stored in the memory in advance, may detect a state in which the protruding portion 101A of the ring-shaped electrode 101 is located on the detection electrode Rx corresponding to the detection signal.

As described above, by arranging the GND electrode GE to which the GND voltage is applied at a position opposed to the ring portion 101B of the ring-shaped electrode 101, capacitance caused by the electrostatic capacitive coupling can be loaded on the detection electrode Rx opposed to the protruding portion 101A of the ring-shaped electrode 101 as shown in FIG. 14. According to this, the waveform of the detection signal read from the detection electrode Rx can be made different from the waveforms of the detection signals read from the other detection electrodes Rx (more specifically, an amplitude smaller than the waveforms of the detection signals read from the other detection electrodes Rx can be obtained). As a result, the touch controller TC can detect the position of the protruding portion 101A of the ring-shaped electrode 101.

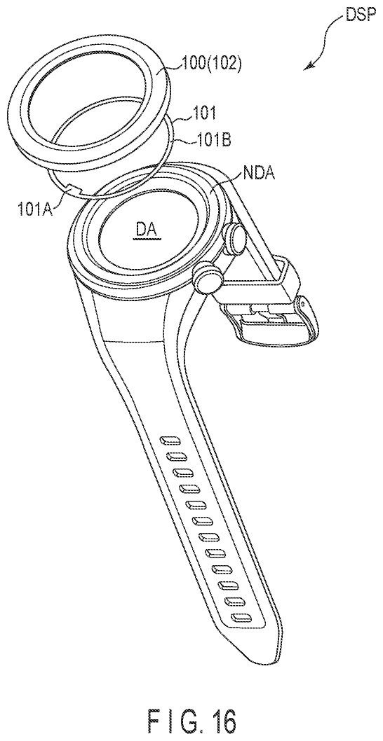

FIG. 16 shows an application example of the display device DSP according to the embodiments. As shown in FIG. 16, the display device DSP is applied to, for example, a wristwatch. In this case, the time and the like are displayed on the display area DA of the display device DSP. The rotating body 100 is arranged at a position overlapping with the non-display area NDA in planar view, and the user causes the display device DSP to execute a predetermined operation by rotating the rotating body 100. The display device DSP detects the protruding portion 101A of the ring-shaped electrode 101 included in the rotating body 100 and executes an operation according to the change in the position of the protruding portion 101A. For example, when detecting the position of the protruding portion 101A of the ring-shaped electrode 101 moving clockwise by one rotation, the display device DSP may execute a preset operation (for example, turning on the backlight BL or the like). Alternatively, the display device DSP detects the protruding portion 101A of the ring-shaped electrode 101 included in the rotating body 100 and executes an operation according to the current position of the protruding portion 101A. For example, the display device DSP may execute an operation of selecting an icon displayed on an extension of the current position of the protruding portion 101A of the ring-shaped electrode 101. Sensors (not shown), a vibration sensor, a gyro sensor, and the like may be further provided in the wristwatch (display device DSP) shown in FIG. 16, and the wristwatch may comprise a function of changing a low consumption mode to an active mode by utilizing the detection results of these sensors.

It has been described that the movable portion 102 is integrated with the rotating body 100 in the embodiments, but the embodiments are not limited to this, and the movable portion 102 may be provided separately from the rotating body 100. In this case, the movable portion 102 may be physically connected to the ring-shaped electrode 101 constituting the rotating body 100.

According to one of the embodiments described above, the display device DSP is arranged at a position where overlaps with the non-display area NDA in planar view, and comprises the rotating body 100 including the ring-shaped electrode 101. In addition, the display device DSP comprises a configuration capable of detecting the protruding portion 101A of the ring-shaped electrode 101 by the mutual capacitive scheme or the self-capacitive scheme. According to this, the display device DSP can execute a predetermined operation according to the current position or the change in position of the protruding portion 101A of the ring-shaped electrode 101, and the user can cause the display device DSP to execute a predetermined operation by rotating the rotating body 100 including the ring-shaped electrode 101.

In addition, since the ring-shaped electrode 101 is floating, a wiring line for electrically connecting the display device DSP and the ring-shaped electrode 101 does not need to be drawn and the ring-shaped electrode can be applied to various display devices DSP.

According to one of the above-described embodiments, a display device and a watch having both display quality upon displaying an image and excellent touch operability can be provided.

Various types of the modified examples are easily conceivable within the category of the ideas of the present invention by a person of ordinary skill in the art and the modified examples are also considered to fall within the scope of the present invention. For example, additions, deletions or changes in design of the constituent elements or additions, omissions, or changes in condition of the processes arbitrarily conducted by a person of ordinary skill in the art, in the above embodiments, fall within the scope of the present invention as long as they are in keeping with the spirit of the present invention.

In addition, the other advantages of the aspects described above in the embodiments, which are obvious from the descriptions of the present specification or which can be arbitrarily conceived by a person of ordinary skill in the art, are considered to be achievable by the present invention as a matter of course.

What is claimed is:

1. A display device comprising:
a display panel comprising a display area for displaying an image, a plurality of first electrodes arranged to surround the display area, and at least one second electrode arranged to surround the plurality of first electrodes; and
a ring-shaped electrode arranged on the display panel and arranged at a position overlapping with the second electrode in planar view,
the ring-shaped electrode comprising a protruding portion overlapping with at least one of the plurality of first electrodes in planar view.

2. The display device of claim 1, wherein
the display panel comprises a cover member on a surface thereof, and
the ring-shaped electrode is arranged on the cover member.

3. The display device of claim 1, wherein
the ring-shaped electrode is floating.

4. The display device of claim 1, wherein
the display panel comprises a first substrate including a display element and a second substrate opposed to the first substrate, and
the plurality of first electrodes and the second electrode are arranged on the second substrate.

5. The display device of claim 1, wherein
a drive circuit for outputting a drive signal is connected to the second electrode,
a detection circuit for outputting a detection signal is connected to the plurality of first electrodes, and
the display device detects a position of the protruding portion of the ring-shaped electrode by a mutual capacitive scheme, based on detection signals output from the plurality of first electrodes, in accordance with inputting the drive signal to the second electrode.

6. The display device of claim 5, wherein
the display device has a display period for displaying an image on the display area and a touch detection period for detecting a position of the protruding portion of the ring-shaped electrode.

7. The display device of claim 1, wherein
a predetermined reference voltage is applied to the second electrode, and
the display device detects a position of the protruding portion of the ring-shaped electrode by a self-capacitive scheme, based on detection signals output from the plurality of first electrodes, in accordance with inputting the drive signals to the plurality of first electrodes.

8. The display device of claim 7, wherein
the display device has a display period for displaying an image on the display area and a touch detection period for detecting a position of the protruding portion of the ring-shaped electrode.

9. A watch comprising the display device of claim 1.
